(19) United States
(12) Patent Application Publication
(10) Pub. No.: US 2009/0284450 A1
(43) Pub. Date: Nov. 19, 2009

(54) LIGHT-EMITTING APPARATUS

(75) Inventors: Koichi Ishige, Mobara-shi (JP); Seishi Miura, Mobara-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/437,920

(22) Filed: May 8, 2009

(30) Foreign Application Priority Data
May 16, 2008 (JP) 2008-129578

(51) Int. Cl. G09G 3/30

(52) U.S. Cl. 345/76

(57) ABSTRACT

When the degradation of a light-emitting device is detected and the luminance is compensated, because the lowering in current efficiency involved in the degradation varies for each luminance, use of the same compensation coefficient provides a luminance region in which the compensation is insufficient. A light-emitting apparatus includes a light-emitting device; a control unit for changing a display luminance of the light-emitting device depending on an input signal; a degradation detection unit for detecting a degradation amount of the light-emitting device; and a correction unit for correcting the input signal depending on a detected degradation amount, wherein the correction unit corrects the input signal depending on the degradation amount of the light-emitting device and the display luminance determined by the input signal.

### BACKGROUND OF THE INVENTION

1. Field of the Invention

The present invention relates to a light-emitting apparatus including a light-emitting device.

2. Related Background Art

Recently, a self-emission type device for a flat panel display attracts attention. Examples of the self-emission type device are a plasma light-emitting device, a field emission device, and an electro luminescence (EL) device.

Among others, particularly research and development on the organic EL device are energetically promoted. In the organic EL device, an area color type array to which color such as green in monochrome, blue, and red is added is already commercialized, and currently full-color is actively developed.

In the organic EL device, it is known that a degradation phenomenon occurs in which a luminance is lowered to raise a voltage with the elapse of drive time.

As to the degradation problem of the organic EL device, for example, Japanese Patent Application Laid-Open No. 2001-236040 discloses a light-emitting apparatus, in which a drive voltage of an organic EL device is detected and a drive power of the organic EL device is controlled depending on the amount of increase in drive voltage to thereby compensate the luminance of the device. According to the light-emitting apparatus disclosed in this patent document, not only the luminance is compensated for a variation in temperature in the organic EL device, but also the luminance can be compensated for a degradation of the device over time.

On the other hand, as a method of performing luminance gradation of an organic EL device, that are included, a method of changing the luminance of the device by controlling a level of the drive current or drive voltage applied to the organic EL device and a pulse-width modulation system of controlling a light emission period by maintaining the drive voltage applied to the organic EL device constant. The former method is adopted in the light-emitting apparatus disclosed in Japanese Patent Application Laid-Open No. 2001-236040 above.

However, as to the former method, the present inventors have made extensive study and have found that not only the voltage-luminance characteristics or current-luminance characteristics of the organic EL device may be changed after the degradation of the organic EL device but also the amount of change or the rate of change of the voltage-luminance characteristics or the current-luminance characteristics may vary depending on the display luminance to be displayed. In such cases, when the drive current or the like is corrected depending on the amount of increase in drive voltage of the organic EL device, the compensation of the luminance can be attained in the case of displaying a certain luminance, while the compensation may be inappropriately performed to change the luminance from the display luminance to be displayed in the case of displaying another luminance.

Incidentally, such problem may occur in not only an organic EL device but also a light-emitting device, when gradation is expressed by changing the luminance.

Further features of the present invention become apparent from the following description of exemplary embodiments with reference to the attached drawings.

### SUMMARY OF THE INVENTION

The present invention has been accomplished in view of the above-mentioned circumstances, and it is, therefore, an object of the present invention to provide a light-emitting apparatus that accurately compensates lowering of a displayed luminance.

The light-emitting apparatus according to an aspect of the present invention includes:

a light-emitting device;

a control unit for changing a display luminance of the light-emitting device depending on an input signal;

a degradation detection unit for detecting a degradation amount of the light-emitting device; and

a correction unit for correcting the input signal depending on a detected degradation amount,

wherein the correction unit corrects the input signal depending on the degradation amount of the light-emitting device and the display luminance determined by the input signal.

### BRIEF DESCRIPTION OF THE DRAWINGS

FIGS. 1A and 1B are graphical representations illustrating an example of a change in luminance over time in an organic EL device.

FIG. 2 is a graphical representation illustrating an example of a luminance-current efficiency relationship during drive degradation in an organic EL device.

FIG. 3 is a graphical representation illustrating an example of a luminance-current efficiency relationship during drive degradation in an organic EL device.

FIG. 4 is a schematic diagram illustrating a light-emitting apparatus according to an embodiment of the present invention.

FIG. 5 is a schematic diagram illustrating an example of a configuration for detecting a drive voltage of an organic EL device of a light-emitting apparatus of the present invention.

FIG. 6 is a correction coefficient table illustrating an example of a correction coefficient of a necessary current amount determined by a display luminance and a degradation amount.

FIG. 7 is a conceptual diagram illustrating a light-emitting apparatus according to another embodiment of the present invention.

FIGS. 8A, 8B, and 8C are graphical representations for explaining a mathematical expression for determining a correction coefficient using a correction coefficient table.

FIG. 9 is a schematic diagram illustrating a light-emitting apparatus according to another embodiment of the present invention.

### DETAILED DESCRIPTION OF THE INVENTION

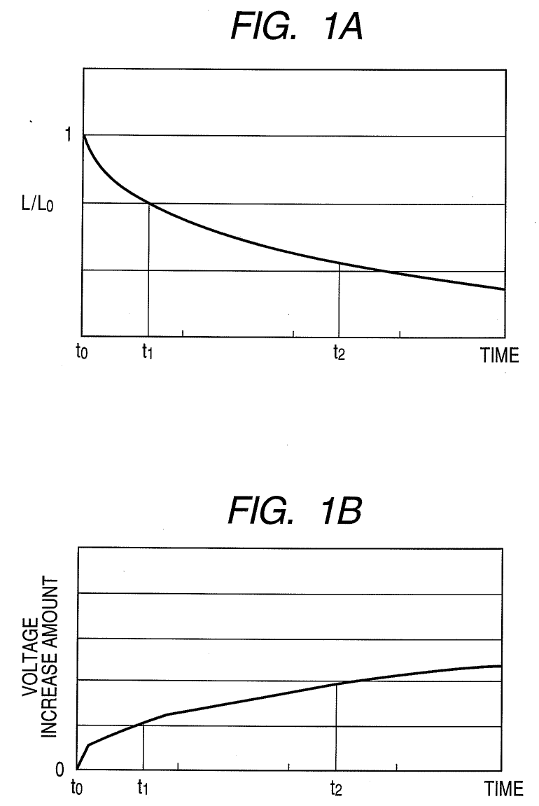

The present invention will be described in detail with reference to FIGS. 1A to 9. Incidentally, in the following description, the luminance of an organic EL device 1 of a light-emitting apparatus that emits light during light emission period is referred to as “display luminance”. For example, in the case of a light-emitting apparatus that expresses gradation by the pulse-width modulation system, when light is emitted at a maximum luminance in a half time, the emitted light can be visually recognized to have substantially half of luminance. In this case, because the light is emitted at the maximum luminance during the light emission period, it is assumed that the “display luminance” of the organic EL device according to this system refers to the maximum luminance.

FIGS. 1A and 1B illustrate a relationship between a time in which an organic EL device is driven at a constant current and a normalized luminance, and a relationship between the time and the amount of increase in voltage, respectively. As shown in FIGS. 1A and 1B, in the case of constant-current drive, there is a tendency that the luminance is lowered while the voltage is increased with the elapse of time.

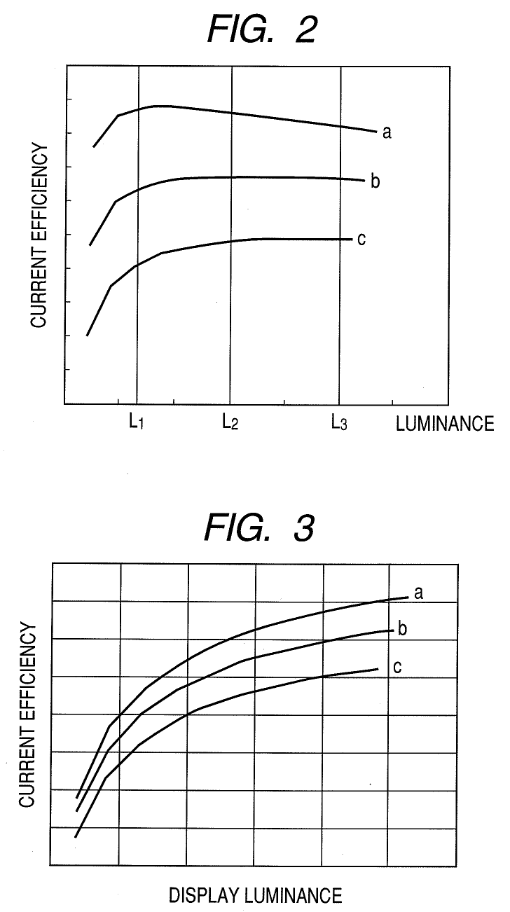

FIG. 2 illustrates a relationship between the luminance and current efficiency at times t₀, t₁, and t₂ during driving of the organic EL device in FIGS. 1A and 1B. In FIG. 2, a, b, and c represent the relationships between the luminance and the current efficiency at times t₀ (initial stage), t₁, and t₂ in FIGS. 1A and 1B, respectively. As can be seen from FIG. 2, when the drive time is lengthened and the organic EL device is degraded, the current efficiency at the same luminance is lowered. This means that the current value necessary to display the same luminance is increased. Furthermore, at the different luminances L1, L2, and L3, it can be seen that as the drive time is lengthened, the rate of lowering in the current efficiency is changed, and that the rate of lowering in the current efficiency is increased on the lower luminance side. Therefore, in an organic EL device that has been driven for a certain period of time, the correction amounts or correction coefficients of the drive currents to the organic EL device differ from one another when light is emitted in the display luminances L1, L2, and L3, respectively. That is, in the light-emitting apparatus which has such degradation characteristics as shown in FIG. 2 and in which the display luminance of the organic EL device is changed, when the correction amount or correction coefficient to the device is determined on the higher luminance side, the effect cannot sufficiently be obtained even when the display luminance of the low luminance side is to be compensated with the correction amount or correction coefficient. Furthermore, the display luminance is deviated when the correction amount or correction coefficient to the device is determined on the lower luminance side and the display luminance on the higher luminance side is to be compensated by the use thereof. The present invention is characterized in that the correction amount or correction coefficient is determined depending on not only the degradation amount of the organic EL device but also the display luminance determined by the input signal of the organic EL device, and the correction is performed using the correction amount or correction coefficient.

Although the reason why the rate of lowering in the current efficiency may vary depending on the display luminance has not been elucidated, it is hypothesized as follows.

In the organic EL device, electrons and holes are injected from respective electrodes and light is emitted from excitons generated by recombination.

The lowering of the luminance accompanying the driving of the device is considered to be attributable to not only that the light-emitting molecules suffer damage to thereby fail to emit light but also that the injection of electron or holes or a change in transporting characteristics is involved. In such cases, the carrier balance may be changed to vary the region where light is emitted in the organic EL device, the number of excitons contributing to the light emission, or the state of carrier leakage, thereby lowering the current efficiency. Furthermore, the state, such as the change of the light-emission region, the number of excitons contributing to the light emission, the carrier leakage, and quenching, which affect the current efficiency may also be changed by an electric field applied to the organic EL device. In such case, it is considered that the influence of the change in luminance due to the degradation over time may vary depending on the display luminance, that is, the applied electric power.

For example, there may be cases where the current efficiency lowering is increased as the luminance is reduced as shown in FIG. 2, and depending on the light-emitting molecule, where the current efficiency lowering is increased as the luminance is enhanced. Furthermore, various states may be caused, for example, where the current efficiency lowering becomes the maximum or minimum at a certain luminance. The use of the light-emitting apparatus of the present invention can correctly compensate the luminance depending on the display luminance to be displayed suitably according to various situations.

FIG. 3 illustrates an example of the relationship between the luminance and the current efficiency in another organic EL device. In FIG. 3, a indicates the relationship before the degradation, b indicates the relationship after the organic EL device has been driven for a predetermined time, and c indicates the relationship after the organic EL device has been driven for a period of time longer than that of the case of b. In the organic EL device of FIG. 3, the current efficiency lowering is increased as the display luminance is enhanced. The present invention can also be applied to the organic EL device of FIG. 3, and the luminance lowering can accurately be compensated depending on the display luminance.

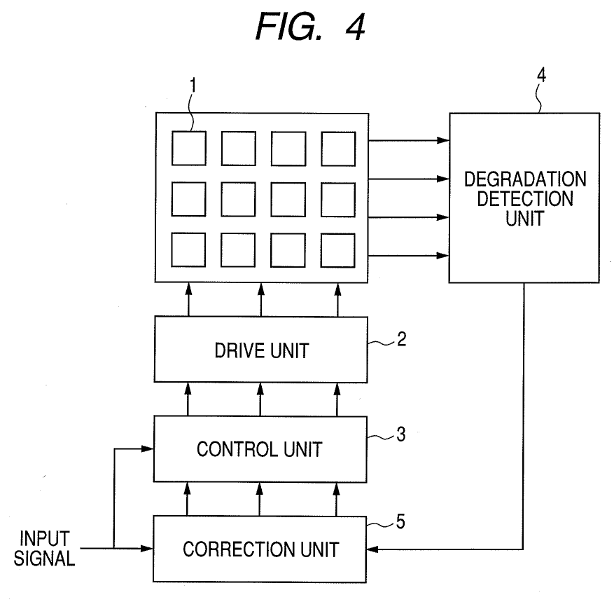

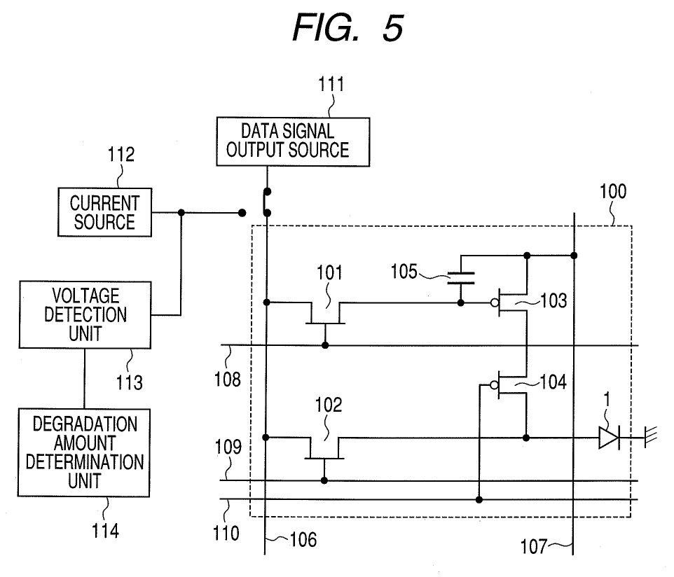

FIG. 4 is a conceptual diagram illustrating the configuration of a light-emitting apparatus according to an embodiment of the present invention. Incidentally, although the following description will be made by taking an organic EL device as an example of the light-emitting device, the present invention can also be applied to a plasma light-emitting device and the like.

The light-emitting apparatus shown in FIG. 4 includes an organic EL device 1, a drive unit 2 that supplies an electric power to drive the organic EL device 1, a control unit 3 that changes the display luminance of the organic EL device 1 in accordance with an input signal, and a degradation detection unit 4 that detects the degradation amount of the display luminance of the organic EL device 1. The light-emitting apparatus also includes a correction unit 5 that corrects the input signal in accordance with the degradation amount. The correction unit 5 corrects the input signal depending on the degradation amount of the organic EL device 1 and the display luminance determined by the input signal. The operation of correcting the input signal is described later. In the case where the luminance of the organic EL device 1 is changed, when the drive current or drive voltage applied to the organic EL device 1 is changed depending on the input signal, the luminance corresponding to the drive current or drive voltage is displayed.

Next, a method of detecting the degradation amount of the organic EL device will be described below. FIG. 1B is a graph in which the amount of increase in voltage is plotted when the organic EL device is driven at a constant current. By utilizing the relationship shown in FIG. 1B, the drive voltage applied to the organic EL device when flowing a current of a certain value therein is detected, which allows the degradation amount of the organic EL device, that is, the amount of increase in drive voltage to be detected.

An example of a configuration in which the voltage applied to the organic EL device when flowing a current of a predetermined value therein is detected will be described with reference to FIG. 5. FIG. 5 illustrates only one pixel of a matrix light-emitting apparatus including a plurality of pixels. A pixel 100 includes at least the organic EL device 1, a first transistor 101, a second transistor 102, a third transistor 103, a fourth transistor 104, a storage capacitor element 105, a data line 106, a power supply line 107, a first selection line 108, a second selection line 109, and a third selection line 110. Outside the pixel, the data line 106 is configured so as to be switchable between the data signal output source 111, and the current source 112 and the voltage detection unit 113. The current source 112, voltage detection unit 113, and a degradation amount determination unit 114 shown in FIG. 5 correspond to the degradation detection unit 4 of the light-emitting apparatus shown in FIG. 4.

The operation of the present embodiment will be described below. First, a light emission operation will be described. In the case of writing into the pixel, the first selection line 108 is set at High while the second selection line 109 and the third selection line 110 are set at Low. Therefore, the first transistor 101 is turned on, the second transistor 102 is turned off, and the fourth transistor 104 is turned on. At the same time, the data line 106 is connected to the data signal output source 111, and a data signal is applied to the data line 106 depending on the display luminance. Therefore, the storage capacitor element 105 stores the data signal, the third transistor 103 flows a current from the power supply line 107 to the organic EL device 1 depending on the data signal, and the organic EL device 1 emits light at a desired display luminance. In the case of writing into another pixel, when the first selection line 108, the second selection line 109, and the third selection line 110 are set at Low, the organic EL device 1 continues to emit light at a display luminance depending on the written data signal by a voltage corresponding to the data signal stored in the storage capacitor element 105.

Next, a drive voltage detecting operation will be described. In this case, the first selection line 108 is set at Low while the second selection line 109 and the third selection line are set at High. The data line 106 is connected to the current source 112 side, and a current of a predetermined value flows in the data line 106. In this state, the potential of the data line 106 becomes equal to the voltage that is applied to the organic EL device 1 when flowing the predetermined current. By detecting this potential with the voltage detection unit 113, the voltage that is applied to the organic EL device 1 when flowing the predetermined current can be detected. The degradation amount determination unit 114 compares the voltage to the initial drive voltage of the pixel concerned to detect the amount of increase in drive voltage as the degradation amount of the organic EL device 1. Incidentally, at this time, for the pixels other than the pixel in which the degradation amount of the organic EL device 1 is detected, the first selection line 108 and the second selection line 109 are set at Low while the third selection line is set at High. Thus, the current supplied from the current source can be flowed only in the pixel the degradation amount of which is to be detected.

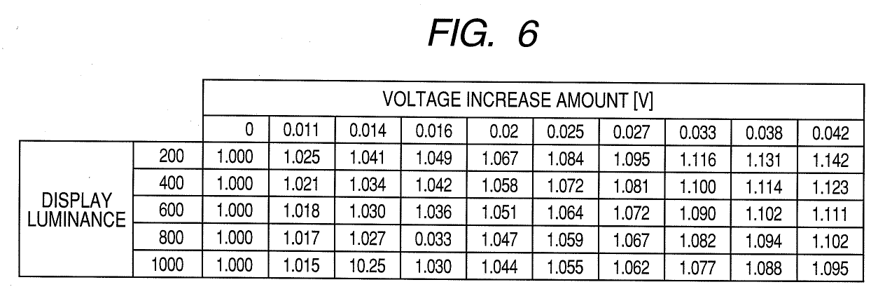

Next, an operation of determining correction information that is used to correct the input signal depending on the display luminance determined by the degradation amount and the input signal will be described below. The correction information refers to a correction amount of the amount of drive current applied to the organic EL device or a correction amount of the value of drive voltage applied to the organic EL device, and the like. The correction information can be preliminarily determined by measuring the degradation characteristics of a light-emitting device having the degradation characteristics that are identical to or similar to those of the organic EL device 1 used in the light-emitting apparatus. For example, a light-emitting device having the same degradation characteristics as the organic EL device 1 is degraded by performing constant-current drive, the constant-current drive is suitably stopped after the elapse of a certain period of time, and the drive voltage applied to the organic EL device or the change in luminance displayed when a current is applied with the current value being changed is measured. After the organic EL device is measured, constant-current drive is performed again to further degrade the light-emitting device. By repeating this procedure, it is possible to determine the current and voltage values necessary to display a certain luminance at a certain degradation time that is defined by a certain constant amount of increase in voltage with respect to a certain constant current value. Thus, in the organic EL device 1, the correction amount is determined while considering how much increase in current amount necessary to display a certain display luminance with respect to the initial current amount can compensate the luminance. Furthermore, a value obtained by dividing the correction amount of the current amount by the initial current amount is determined as a correction coefficient, and the correction coefficient may be used as the correction information. FIG. 6 is a current-amount correction coefficient table for a light-emitting device (in this case, an organic EL device having the same configuration as the organic EL device 1) having the same degradation characteristics as the organic EL device 1, which corresponds to the display luminance determined by the degradation amount and the input signal. That is, in FIG. 6, the degradation amount is expressed by the amount of increase in drive voltage value with respect to the initial drive voltage value when a current of a certain amount is flowed, and the correction coefficient is expressed by the rate of increase with respect to the initial current value. The correction unit 5 in the light-emitting apparatus of FIG. 4 stores the thus previously obtained current-amount correction coefficient table as the correction information data, refers to the correction information data of the current amount from the amount of increase in voltage of the organic EL device 1 and the display luminance determined by the input signal, and determines the correction coefficient of the necessary current amount as the correction information. Moreover, the correction unit 5 determines the current amount obtained by multiplying the initial current amount by correction coefficient as the correction amount, and the correction unit 5 corrects the input signal such that this correction amount is applied to the organic EL device 1 in addition to the initial current amount. Furthermore, instead of the current-amount correction coefficient table, the correction unit 5 may store the current-amount correction amount table as the correction information data.

Incidentally, the light-emitting device having the degradation characteristics that are identical to or similar to those of the organic EL device 1 is not limited to the organic EL device but may be other types of light-emitting devices.

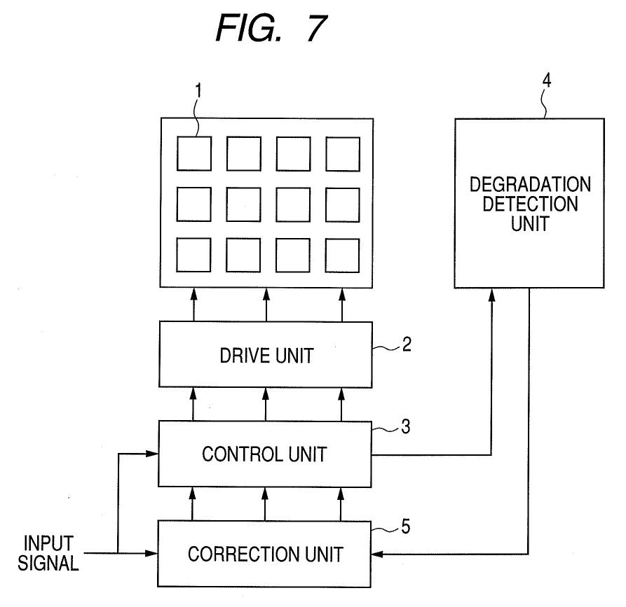

In the present invention, the degradation amount of the organic EL device includes the amount of increase in drive voltage. However, the degradation amount of the organic EL device is not limited to the amount of increase in drive voltage. For example, FIG. 7 illustrates a light-emitting apparatus according to another embodiment. The degradation detection unit 4 obtains information on the display luminance displayed on the organic EL device and information on a time period in which the display is performed at that display luminance through the control unit 3. Then, the degradation detection unit 4 computes a sum of products of the display luminances and the time periods in which the display is performed at those display luminances, that is, a cumulative drive time of the organic EL device, and the degradation detection unit 4 utilizes the cumulative drive time as the degradation amount. Furthermore, the correction unit 5 stores the correction information data that is determined from the relationship between the thus previously obtained cumulative drive time and the display luminance, and the correction unit 5 may determine the correction information (for example, correction coefficient with respect to drive current amount) depending on the cumulative drive time and the display luminance.

Furthermore, the degradation detection unit 4 may measure a luminance that is actually displayed by the organic EL device, and the degradation amount of the luminance when a constant current is flowed may directly be obtained. Even when any method is employed, by previously determining the relationship between the degradation amount previously detected by the degradation detection unit 4 and the correction information (correction amount or correction coefficient) on the necessary current amount in each display luminance, the effect of the present invention can satisfactorily be exhibited.

The present invention can also be applied to the system in which the voltage is varied to vary the luminance of an organic EL device. In this case, it is necessary to store a table indicating the correction information (correction amount or correction coefficient) on the necessary voltage value corresponding to the degradation amount of the device and the display luminance.

Furthermore, the amount of increase with respect to the initial current amount is not employed, and a necessary current amount table corresponding to the display luminance may previously be stored, and the necessary current amount output to the device depending on the display luminance determined by the degradation amount and the input signal may be determined.

The correction coefficient may be provided for each minute degradation amount for all the display luminances. However, in this case, the data capacity retained by the correction unit 5 becomes excessively large. Therefore, only the correction coefficient in a certain specific luminance and a certain specific degradation amount may be stored as correction information data, and the display luminance and degradation amount that are located between the stored correction information data may be interpolated by a linear or high-order polynomial expression or an arbitrary function. In such cases, the data capacity for retaining the correction information can be reduced, which is more preferable.

Furthermore, instead of the procedure in which the correction information data is approximated by a certain mathematical expression and the data of the correction information is stored, the mathematical expression may be stored. The correction information may be computed by entering the display luminance determined by the degradation amount of the device and the input signal into the mathematical expression. In such cases, the store capacity used to store the correction information data can be reduced, which is more preferable.

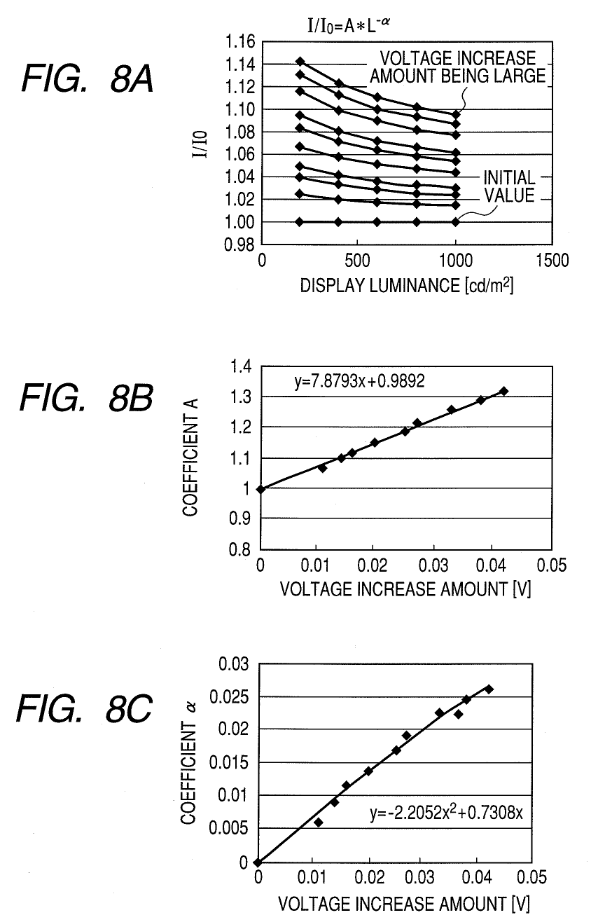

FIG. 8 illustrates an example of a method of obtaining the mathematical expression. FIG. 8A is a graph in which the display luminance and the current correction coefficient (the rate of increase with respect to the initial current amount) are plotted for each amount of increase in voltage. That is, the correction coefficients are plotted with respect to the display luminances of FIG. 6, and the correction coefficients with the same amount of increase in voltage are smoothly connected. The relationship between the display luminance and the correction coefficient can be approximated for each amount of increase in voltage by an Expression 1.

I/I0=A×L−α Expression 1

In the expression, L is the display luminance, and A and α are coefficients in performing the approximation. FIG. 8B is a graph in which the relationship between the obtained coefficient A and the amount of increase in voltage (ΔV) is plotted. This relationship can linearly be approximated and expressed by A=a×ΔV+b. Similarly, the relationship between the other coefficient α and the amount of increase in voltage can be approximated by α=c×(ΔV)²−d−ΔV (see FIG. 8C). Here, a, b, c, and d are constant that are determined depending on the organic EL device. Thus, the current correction coefficient can be computed from the display luminance and the amount of increase in voltage using the mathematical expression.

The constitution of the mathematical expression is not limited to the above-mentioned, but any constitution of the mathematical expression may be used as long as it can describe the relationship between the correction coefficient, and the degradation amount and the display luminance.

The present invention can be applied to not only a light-emitting apparatus (for example, illumination lamp) including a single organic EL device but also a light-emitting apparatus including a plurality of organic EL devices. In the light-emitting apparatus including a single organic EL device, the luminance lowering caused by the degradation of the driving device can satisfactorily be compensated for every display luminance at the display luminance displayed. In the case where the invention is applied to the light-emitting apparatus including a plurality of organic EL devices, the luminance lowering can be compensated for every device and for every display luminance at each luminance to be displayed. The detection of the degradation amount and the correction of the luminance are performed in each of the plurality of organic EL devices, so that visual recognition as image burn-in of the degradation amount depending on the device can be prevented in different luminances.

On the other hand, in cases where the gradation is expressed by the pulse-width modulation, the effect of the present invention is exhibited when the luminance of the organic EL device is changed in addition to the modulation of the light emission period. For such an example, the luminance of the whole light-emitting apparatus is adjusted by switching between a low luminance mode and a high luminance mode is mentioned. When the displayed two luminances differ from each other in the rate of the current efficiency lowering caused by the degradation over time, the present invention can be applied to compensate the luminance lowering caused by the degradation in each display luminance. In such cases, it is only necessary to store the correction amount or correction coefficient corresponding to the display luminance in each luminance mode as the correction amount or correction coefficient. In this case, the capacity for storing the correction amount or correction coefficient can be reduced as compared to the system of displaying gradation by changing the luminance, which is advantageous.

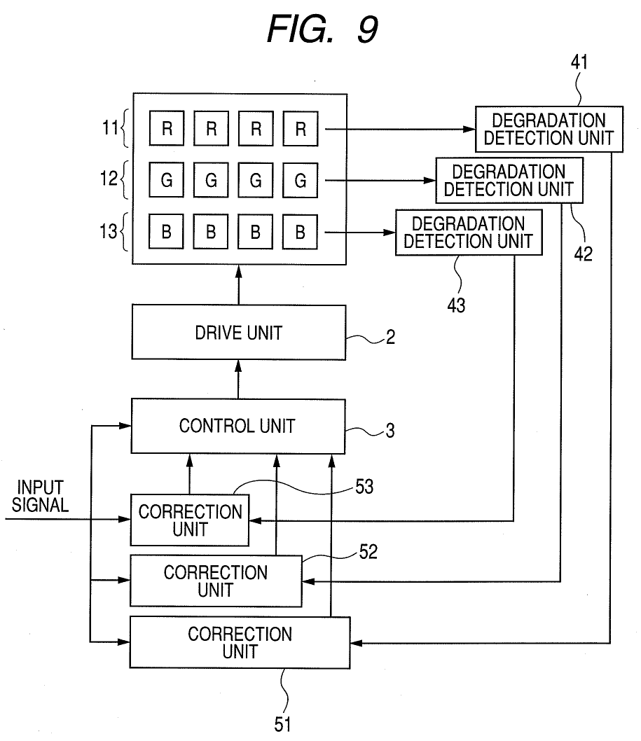

According to another embodiment of the present invention, in a light-emitting apparatus including a plurality of organic EL devices having different degradation characteristics, the stored correction information data may vary for each of the devices having the different degradation characteristics. For example, as shown in FIG. 9, in a light-emitting apparatus including organic EL devices having different emission colors such as R, G, and B, there may be cases where the degradation amounts caused by driving the organic EL devices or the current amount necessary for the luminance displayed may differ from one another. In such cases, because the correction amount depending on the display luminance determined by the degradation amount or the input signal differs for each color, it is preferable that a degradation detection unit that detects the degradation and a correction unit that stores the correction information data, determines appropriate correction information, and corrects the input signal are provided for each of the devices having the different emission colors. A first degradation detection unit 41 detects the degradation amount of an organic EL device 11 that emits an emission color R, and a first correction unit 51 determines the correction coefficient as the correction information based on the display luminance that is determined by the degradation amount and the input signal. Similarly a second degradation detection unit 42 and a third degradation detection unit 43 detect the degradation amounts of organic EL devices 12 and 13 that emit emission colors G and B, respectively, and a second correction unit 52 and a third correction unit 53 determine the correction coefficients of the organic EL devices 12 and 13 based on the display luminances that are determined by the degradation amount and the input signal. In this case, the correction is performed corresponding to the organic EL devices having the different degradation characteristics, so that compensation can be performed such that the change in luminance is reduced in each device. In the embodiment, the degradation detection unit is provided for each of the devices having the different degradation characteristics. However, a single degradation detection unit may detect the degradation amounts of all the devices. In this case, switching may be performed such that detection results are supplied to the plurality of correction units provided in each of the devices having the different degradation characteristics.

The degradation detection unit 4 may not detect the degradation amount from the device for which compensation is performed. The degradation amount of the device for which the correction is to be made may be estimated from the degradation amount of another device subjected to the same drive operation as that of the device for which the compensation is to be performed.

As to the frequency at which the degradation is detected, the degradation detection unit may detect the degradation amount each time the writing is performed, or the detection operation may be performed at intervals whenever the writing is performed a given number of times. In cases where the detection operation is performed at intervals whenever the writing is performed a given number of times, the degradation amount of each organic EL device is stored, and the correction coefficient may be determined from the stored degradation amount and display luminance of each organic EL device when the detection operation is not performed.

### EXAMPLE

When a current was flowed in an organic EL device at a current density of 30 mA/cm², the initial luminance was 1140 cd/m², and the drive voltage was 4.03 V. The current densities necessary to emit light of the luminances of 200 cd/m², 600 cd/m², and 1000 cd/m² were 5.19 mA/cm², 15.52 mA/cm², and 26.14 mA/cm², respectively. Next, when the current of 30 mA/cm² was continuously flowed in the device, the luminance was lowered to 1049 cd/m² while the drive voltage was increased to 4.072 V after 2.8 hours. At this time, when the current density necessary to attain each of the luminances of 200 cd/m², 600 cd/m², and 1000 cd/m² was measured, the current densities were 5.92 mA/cm², 17.24 mA/cm², and 28.63 mA/cm², respectively. Accordingly, the correction coefficients of the current density necessary to attain the luminances 200 cd/m², 600 cd/m², and 1000 cd/m² were 1.142, 1.111, and 1.095, respectively, in the device that was degraded such that the voltage was increased by 0.042 V. FIG. 6 illustrates the correction coefficient table as the correction information data that is derived from the relationship between the amount of increase in voltage and the display luminance. Furthermore, an expression for determining the correction coefficients of the luminances therebetween (400 cd/m² and 800 cd/m²) was stored as y=1.3129x−0.0262. In the expression, x represents the display luminance and y represents the correction coefficient in the display luminance when the voltage increase amount is 0.042 V.

A current of 30 mA/cm² was flowed in another organic EL device having the same degradation characteristics as above, so that the organic EL device was degraded until the voltage was increased by 0.042 V. In case where the display luminance to be displayed was 200 cd/m², when the current was corrected with the correction coefficient of 1.142, the actually displayed luminance was 198 cd/m². Furthermore, in cases where the display luminances were 600 cd/m² and 1000 cd/m², the current for flowing in the device was corrected with the correction coefficients of 1.111 and 1.095, respectively. As a result, the actually displayed luminances were 599 cd/m² and 1000 cd/m², respectively, the luminance was appropriately compensated for each display luminance.

When the correction coefficients for the display luminances of 400 cd/m² and 800 cd/m² were determined by using the expression of y=1.3129x−0.0262 for computing the correction coefficient for the luminance between the stored correction coefficients, the correction coefficients obtained were 1.122 and 1.102, respectively. As shown in FIG. 6, the obtained correction coefficients are substantially equal to the initially computed values of 1.123 and 1.102, so that the luminance lowering can also be prevented at the luminance for which the correction coefficient is not directly stored.

### Comparative Example

A current of 30 mA/cm² was flowed in an organic EL device having the same degradation characteristics as those of Example, so that the organic EL device was degraded until the voltage was increased by 0.042 V. At this time, the amount of a current for flowing in the device was corrected based on the correction coefficient of 1.095 that was used when the luminance of 1000 cd/m² was to be displayed. When each of the luminances of 200 cd/m², 600 cd/m², and 1000 cd/m² was tried to be displayed, the actually displayed luminances were 190 cd/m², 590 cd/m², and 1000 cd/m², with the results that the luminance was not sufficiently corrected on the lower luminance side.

According to the present invention, because the luminance is compensated depending on the degradation amount of a light-emitting device and the luminance to be displayed of the light-emitting device, the light-emitting apparatus that accurately compensates the luminance lowering can be obtained.

This application claims the benefit of Japanese Patent Application No. 2008-129578, filed May 16, 2008, which is hereby incorporated by reference herein in its entirety.

What is claimed is:

1. A light-emitting apparatus comprising:
a light-emitting device;
a control unit for changing a display luminance of the light-emitting device depending on an input signal;
a degradation detection unit for detecting a degradation amount of the light-emitting device; and
a correction unit for correcting the input signal depending on a detected degradation amount,
wherein the correction unit corrects the input signal depending on the degradation amount of the light-emitting device and the display luminance determined by the input signal.

2. The light-emitting apparatus according to claim 1, wherein the light-emitting device is provided in plurality,
the control unit changes the display luminance of each of the light-emitting devices depending on the input signal,
the degradation detection unit detects the degradation amount of each of the light-emitting devices, and
the correction unit corrects each input signal corresponding to the display luminance depending on the degradation amount of each of the light-emitting devices and the display luminance of each of the light-emitting devices determined by the input signal.

3. The light-emitting apparatus according to claim 2, wherein the control unit changes a drive current of each of the light-emitting devices depending on the input signal to thereby vary the display luminance of each of the light-emitting devices.

4. The light-emitting apparatus according to claim 3, wherein the correction unit retains correction information data for correcting the drive current previously determined of each of the light-emitting devices, determines correction information from among the correction information data depending on the degradation amount of each of the light-emitting devices and the display luminance of each of the light-emitting devices determined by the input signal, and corrects the input signal based on the correction information.

5. The light-emitting apparatus according to claim 3, wherein the control unit computes correction information for correcting a drive current of each of the light-emitting devices from a relationship between the degradation amount of each of the light-emitting devices and the display luminance of each of the light-emitting devices determined by the input signal, and corrects the input signal based on the correction information.

6. The light-emitting apparatus according to claim 2, wherein the degradation detection unit detects a drive voltage of each of the light-emitting devices.

7. The light-emitting apparatus according to claim 2, wherein the degradation detection unit detects the display luminance of each of the light-emitting devices.

8. The light-emitting apparatus according to claim 2, wherein the degradation detection unit computes a cumulative drive time from a product of the display luminance of each of the light-emitting devices determined by the input signal and a drive time at the display luminance.

9. The light-emitting apparatus according to claim 2, wherein the light-emitting devices include a plurality of light-emitting devices having different degradation characteristics, and the correction unit is provided in plurality each corresponding to one of the light-emitting devices having different degradation characteristics.
